(19) United States
(12) Patent Application Publication
(10) Pub. No.: US 2008/0059127 A1
(43) Pub. Date: Mar. 6, 2008

(54) Spatio-temporal reasoning method of moving object based path data

(75) Inventors: Jeehyong Lee, Suwon (KR); Taebok Yoon, Suwon (KR); Dookyung Park, Suwon (KR)

Correspondence Address: EDWARDS ANGELL PALMER & DODGE LLP, P.O. BOX 55874, BOSTON, MA, 02205, US

(73) Assignee: Sungkyunkwan University Foundation for Corporate Collaboration, Suwon (KR)

(21) Appl. No.: 11/706,603

(22) Filed: Feb. 13, 2007

(30) Foreign Application Priority Data
Sep. 4, 2006 (KR) 10-2006-0084834

(51) Int. Cl. G06F 7/60

(52) U.S. Cl. 703/2

(57) ABSTRACT

Disclosed is a method for predicting the spatial/temporal location of a moving user based on analysis of his/her past movement paths. The method includes the steps of defining a similarity function based on a location of each point of a movement path of a user, a time point when the user arrives at the location, and a movement direction of the user so that similarity between a collected path and a current movement path can be measured; measuring similarity between paths based on dynamic time warping; and predicting a movement path of the user based on the measurement.

### CROSS-REFERENCE TO RELATED APPLICATION

The present application claims, under 35 U.S.C. §119(a), the benefit of Korean Patent Application No. 10-2006-0084834, filed Sep. 4, 2006, the entire contents of which are hereby incorporated by reference.

### BACKGROUND OF THE INVENTION

1. Field of the Invention

The present invention relates to a method for predicting a location of a user, and more particularly to a method for predicting a spatial/temporal location of a moving user based on analysis of his/her past movement paths.

2. Background Art

There have been numerous studies for providing users with adaptive services. In general, to provide an adaptive service, user-related data such as time, temperature, humidity, location, etc. are required to be collected and analyzed. Analyzed data can be used as valuable information. Various prediction methods are applied to such analyzed data/information to provide a user with adaptive service.

Examples of use of analysis and prediction results of data collected from a user include prediction of whether or not the user will play tennis based on the weather; creation of an NPC (Non-Player Character) adapted to the game management tendency of a player; and provision of environments adapted to the user's emotional condition. Similarly, technology for collecting, analyzing, and predicting a user's movement path is also useful for providing the user with an adaptive service.

Particularly, if answers can be made to questions such as “where is Mr. Doe heading now after leaving home at 9 a.m.?,” “where is he going to drop by?,” and “where is he supposed to be 30 minutes from now?,” various useful services may be provided in this connection.

For a better understanding, it is assumed that Mr. Doe usually takes a walk on Sunday as exercise. Data regarding the path and time of his recent walks are given in FIG. 2. In the drawing, H refers to his house, Pᵢ refers to each point visited during his walk, and the number given together with each point as a pair refers to the time taken to reach that point from the starting point. If answers can be made to questions such as “how many minutes will it take for Mr. Doe to return home after leaving for a walk?” and “if Mr. Doe is now at point P₃ and it took 13 minutes to get there, when is he going to reach point P₇?,” he may be provided with more diversified services. Particularly, bath water can be prepared for Mr. Doe's arrival at home.

Alternatively, if Mr. Doe is expected to go through point P₇, information regarding the path from points P₃ to P₇ may be provided, or a job that Mr. Doe is supposed to do at point P₇ may be prepared for. Such technology is useful not only for user services, but also for development of intelligent NPCs for predicting the movement of players in a game. Furthermore, the technology can also be used to provide services convenient for daily life, predict the location of a desired product, provide location-based marketing/advertisement services, etc.

Technologies used for location-based services are classified into location recognition technology and location prediction technology. The location recognition technology is based on various means, such as mobile communication networks (e.g. CDMA, GSM/GPRS), satellites (e.g. GPS), and sensors using infrared rays, ultrasound waves, RF signals, or image recognition. However, to date, researches have been focused rather on technologies for recognition and spatial databases than on those for analyzing movement path data. This means that it is difficult to analyze data for prediction by using conventional technologies. Consequently, their application to various prediction technologies for the purpose of providing users with adaptive services is limited.

### SUMMARY OF THE INVENTION

Accordingly, the present invention has been made to solve the above-mentioned problems, and an object of the present invention is to provide a method for predicting the spatial location of a moving user based on data regarding his/her movement paths for the sake of application to various prediction technologies in order to provide the user with adaptive service.

In order to accomplish this object, in one aspect, the present invention provides a method for predicting a spatial/temporal location of a moving object based on movement path data, the method comprising the steps of: defining a similarity function based on a location of each point of a movement path of a user, a time point when the user arrives at the location, and a movement direction of the user so that similarity between a collected path and a current movement path can be measured; measuring similarity between paths based on dynamic time warping; and predicting a movement path of the user based on the measurement. In a preferred embodiment, similarity between a point P(pᵢ, tᵢ) and a point Q(qⱼ, tⱼ) is defined by the following equation

$$nodeSim ( {p}_{i} , {q}_{j} ) = {{C}_{1}^{D} [ cos \frac{θ}{2} ]}^{{C}_{2}} {C}_{3}^{T}$$

wherein, C₁, C₂, and C₃ refer to constants regarding distance, direction, and time, respectively; T=|tᵢ-tⱼ|; D refers to the distance between two points pᵢ and qⱼ; and θ refers to the included angle between pᵢ and qⱼ.

Preferably, the constants C₁, C₂, and C₃ can be determined by the user.

Preferably, the similarity nodeSim(pᵢ, qⱼ) has a result value between 0 and 1, and a similarity threshold value may suitably be determined according to circumstances and conditions so that a suitable path can be selected.

Preferably, the included angle can be calculated by the following equation.

$$θ = \{ \begin{matrix} {cos}^{- 1} \frac{( {p}_{i} - {p}_{i - 1} ) \cdot ( {q}_{j} - {q}_{j - 1} )}{\vert {p}_{i} - {p}_{i - 1} \vert \vert {q}_{j} - {q}_{j - 1} \vert} , & if i \neq 0 \& j \neq 0 \\ 0 , & otherwise .\end{matrix}$$

Also preferably, similarity between paths P and Q can be calculated by the following equation

$$PathSim ( P , Q ) = max {\sum }_{i = 0 , j = 0}^{m , n} nodeSim ( {p}_{i} , {q}_{j} ) .$$

In another preferred embodiment, the method may further comprises a step of selecting paths similar to the current movement path of the user based on similarity measurement and choosing from the selected paths a path that can represent the selected paths.

When similarity between a collected movement path and the current movement path is measured, a weight may suitably be given in proportion to the length of the current movement path.

In another aspect, the present invention provides a method for predicting a spatial/temporal location of a moving object based on movement path data, the method comprising the steps of: collecting past movement paths of a user; measuring a matching degree between the past movement paths; selecting matching movement paths from all past movement paths and excluding non-matching movement paths based on the measured matching degree; measuring similarity between each matching past movement path and a movement path of the user up to the present time so as to analyze movement characteristics of the currently moving user; and predicting a spatial location of the moving user based on the measured similarity.

In a preferred embodiment, the method may further comprise, after the step of measuring similarity, a step of selecting suitable paths having a similarity measurement value within a similarity threshold.

In another preferred embodiment, the method may further comprise a step of choosing from the selected paths a path that can represent the selected paths.

Preferably, a spatial/temporal prediction service can be provided based on the selected paths.

Also preferably, the matching degree and the similarity are measured by an identical method.

For example, similarity between a point P(pᵢ, tᵢ) and a point Q(qⱼ, tⱼ) can be defined by the following equation

$$nodeSim ( {p}_{i} , {q}_{j} ) = {{C}_{1}^{D} [ cos \frac{θ}{2} ]}^{{C}_{2}} {C}_{3}^{T}$$

wherein, C₁, C₂, and C₃ refer to constants regarding distance, direction, and time, respectively; T=|tᵢ-tⱼ|; D refers to the distance between two points pᵢ and qⱼ; and θ refers to the included angle between pᵢ and qⱼ.

Preferably, the constants C₁, C₂, and C₃ can be determined by the user.

Also preferably, the similarity nodeSim(pᵢ,qⱼ) has a result value between 0 and 1, and a similarity threshold value may suitably be determined according to circumstances and conditions so that a suitable path can be selected.

The included angle can be calculated by the following equation

$$θ = \{ \begin{matrix} {cos}^{- 1} \frac{( {p}_{i} - {p}_{i - 1} ) \cdot ( {q}_{j} - {q}_{j - 1} )}{\vert {p}_{i} - {p}_{i - 1} \vert \vert {q}_{j} - {q}_{j - 1} \vert} , & if i \neq 0 \& j \neq 0 \\ 0 , & otherwise .\end{matrix}$$

Preferably, similarity between paths P and Q can be calculated by the following equation

$$PathSim ( P , Q ) = max {\sum }_{i = 0 , j = 0}^{m , n} nodeSim ( {p}_{i} , {q}_{j} ) .$$

When similarity between a collected movement path and a current movement path is measured, a weight may preferably be given in proportion to the length of the current movement path.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart showing a method for selecting a movement path;

FIG. 2 shows an example of collection and prediction of movement paths;

FIG. 3 shows a process for selecting a movement path;

FIG. 4 shows an example of movement paths collected from a user;

FIG. 5 shows a method for extracting the included angle necessary to analyze a movement path;

FIG. 6 shows an example of measurement of similarity between paths in a lattice space;

FIG. 7 shows three methods for matching movement paths;

FIG. 8 shows paths after movement along them is over;

FIG. 9 shows the average of two paths; and

FIG. 10 shows a method for. measuring the similarity for each section by using collected paths and a path along which the user is moving.

### DETAILED DESCRIPTION OF THE PREFERRED EMBODIMENTS

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

In a preferred embodiment, dynamic time warping is used to measure similarity between paths. By using the measured similarity, paths similar to the current movement path are selected from stored data regarding movement paths. Based on the selected paths, a spatial location of the moving user is predicted.

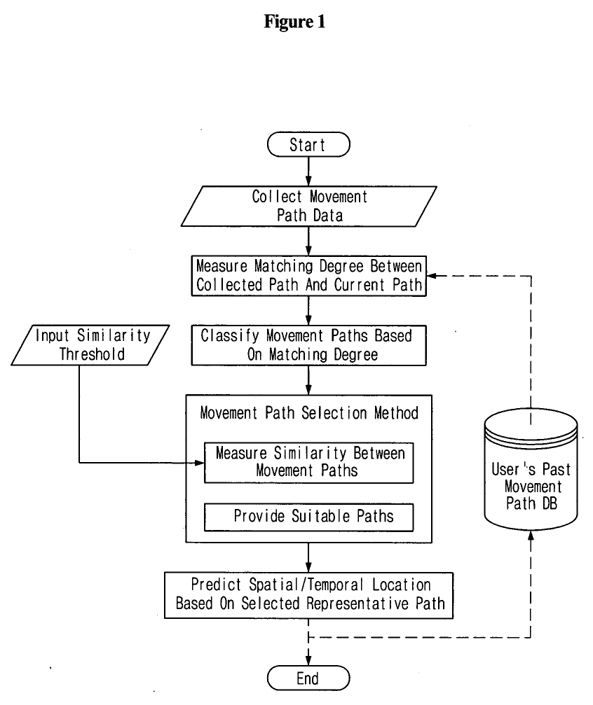

FIG. 1 is a flowchart showing a method for predicting the spatial location of a moving user according to the present invention. Referring to FIG. 1, the user's past movement paths are collected as data, and the matching degree between the past movement paths is measured. The matching degree is used to select matching movement paths from all the past movement paths and exclude non-matching movement paths. In order to analyze the movement characteristics of a currently moving user, the similarity between his/her movement path up to the present and each matching past movement path is measured. The measurement of similarity is followed by selection of suitable paths, the measured similarity of which lies within a similarity threshold. From the suitable paths, a path that can represent the paths is selected. The selected representative path is used to provide a service for predicting a spatial/temporal location.

The matching degree and the similarity are measured in the same manner, except that the matching degree concerns past movement paths only, but the similarity concerns both the past movement paths selected based on the matching degree and the user's current movement path. Hereinafter, a method for measuring the similarity will solely be described for convenience of description.

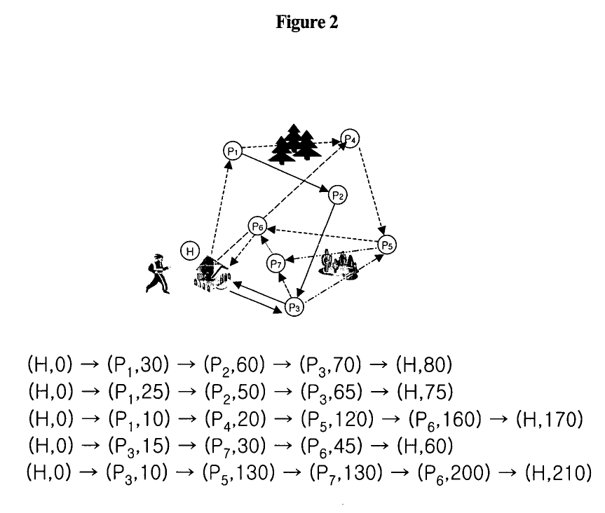

As an example to illustrate preferred embodiments of the present invention, FIG. 2 shows data regarding user's past movement paths. The data is analyzed to provide a technique for predicting the destination of the currently moving user, the path the user is likely to select, the location at which he/she is supposed to be at a specific point of time, and the time he/she is going to reach a particular location, etc.

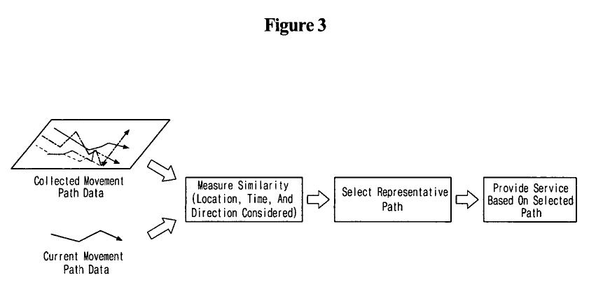

To this end, a similarity function is defined for each point of the movement paths while considering when and in which movement direction the user is going to reach the point so that the similarity between respective paths can be measured. Then, dynamic time warping is used to measure the similarity between paths. In order to analyze the movement characteristics of the currently moving user, the similarity between his/her movement path up to the present and each collected movement path is measured. The resulting similarity is used to analyze the characteristics of the movement paths (FIG. 3).

The approach proposed by the present invention is based on the similarity between two paths. A path is defined by a set of coordinate pairs of a point existing on the path and the time at which the user goes through the point. For example, if the user starts from point p₀ at time point 0, passes through p₁ at 30, p₂ at 40, and p₃ at 65, and reaches p₄ at 80, this path P is defined by equation (1) below.
P={(p₀,0)(p₁,30)(p₂,40)(p₃,65)(p₄,80)} (1)

Similarly, another path Q is defined by equation (2) below.
Q={(q₀,0)(q₁,20)(q₂,50)(q₃,70)(q₄,75)(q₅,90)} (2)

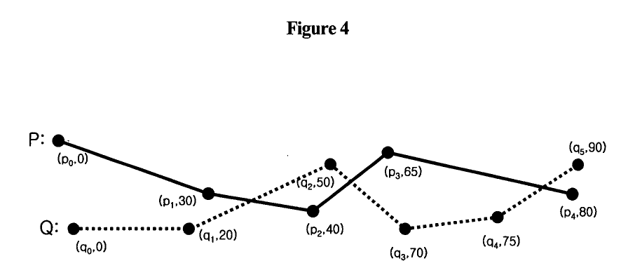

It is also possible to visualize these paths P and Q by marking dots corresponding to respective points of the paths, as shown in FIG. 4.

To what extent are the two paths P and Q said to be similar to each other? To answer this, the similarity between a point of path P and a point of path Q has been defined. This is because the similarity between paths can be defined based on how many similar points they include. For instance, the similarity between a point (p_{i, t}ᵢ) of path P and a point (qⱼ, tⱼ) of path Q is defined by equation (3) below.

$$nodeSim ( {p}_{i} , {q}_{j} ) = {{C}_{1}^{D} [ cos \frac{θ}{2} ]}^{{C}_{2}} {C}_{3}^{T} \qquad ( 3 )$$

Wherein, C₁, C₂, and C₃ are constants; T=|tᵢ−tⱼ|; D refers to the distance between two points pᵢ and qⱼ; and θ refers to the included angle between pᵢ and qⱼ.

According to the present invention, when a similarity between paths is measured, a distance between them, directionality, and time factors are considered during calculation. Particularly, C₁ is a distance constant; C₂ is a time constant having a value between 0 and 1; D refers to the physical distance between two points; T refers to the time difference between two points, i.e. |tᵢ-tⱼ|; C₂ is a constant for a defining the direction; and θ refers to the included angle between two points after movement (described later in more detail). Constants C₁, C₂, and C₃ are determined by the user as weights regarding the distance, direction, and time, respectively. For example, if the user wants to place a higher value on time, the value of C₃ is set to be larger than that of C₁ and C₂. As such, each constant is adjusted by the user according to the application field and circumstances.

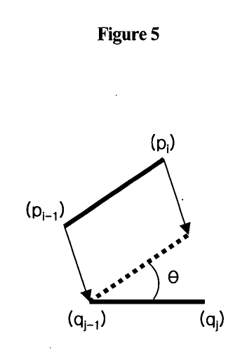

The similarity nodeSim(pᵢ,qⱼ) has a result value between 0 and 1 and, the more similar two compared elements are to each other, the closer to 1 the result value is. The threshold value for the similarity can be determined based on circumstances and conditions so that suitable paths can be selected. Referring to FIG. 5, pᵢ and pᵢ₋₁ are translated to obtain the included angle θ between two movement paths, as defined by equation (4) below.

$$θ = \{ \begin{matrix} {cos}^{- 1} \frac{( {p}_{i} - {p}_{i - 1} ) \cdot ( {q}_{j} - {q}_{j - 1} )}{\vert {p}_{i} - {p}_{i - 1} \vert \vert {q}_{j} - {q}_{j - 1} \vert} , & if i \neq 0 \& j \neq 0 \\ 0 , & otherwise\end{matrix} \qquad ( 4 )$$

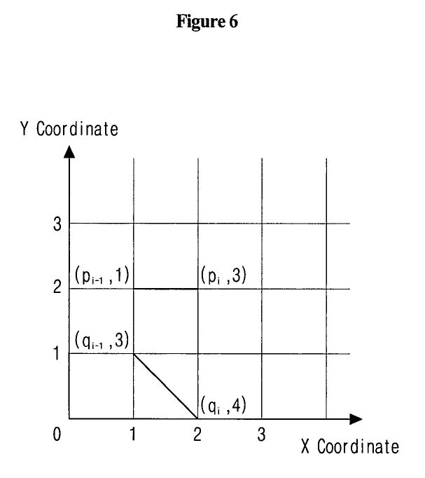

It is clear from equation (4) that the included angle θ between two vectors (pᵢ-pᵢ₋₁) and (qⱼ-qⱼ₋₁) is zero if one of i and j is zero. FIG. 5 shows the definition of θ. In case of pᵢ and qⱼ as shown in FIG. 6, it takes 2 time units (3−1=2) to move along path P leading from Pᵢ₋₁, to pᵢ, and it takes 1 time unit (4−3=1) to move along path Q leading from qⱼ₋₁ to qⱼ. Assuming that C₁=0.7, C₂=2, and C₃=0.7 for calculation, and considering that D=2, T=1, and θ=π/4, the similarity is obtained as in equation (5) below.

$$nodeSim ( {p}_{i} , {q}_{j} ) = {0.7}^{2} \cdot {( cos \frac{π}{8} )}^{2} \cdot {0.7}^{1} = 0.29 \qquad ( 5 )$$

The similarity between two points has a value of 1 only if their location, time, and direction of movement from the previous point are the same. Based on this, the similarity between paths P and Q is defined by equation (6) below.

$$PathSim ( P , Q ) = max {\sum }_{i = 0 , j = 0}^{m , n} nodeSim ( {p}_{i} , {q}_{j} ) \qquad ( 6 )$$

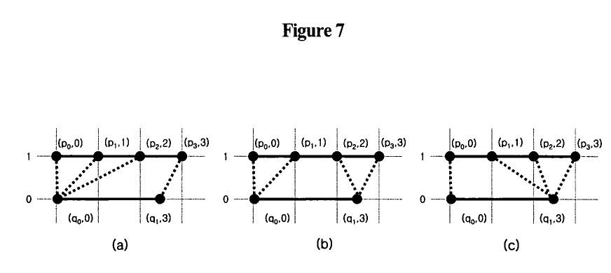

It can be understood from the above equation that the similarity between paths P and Q is defined by pairing every point of path P with every point of path Q in order of time while allowing reduplication and obtaining the sum of the similarity values of pairs, all of which have the maximum similarity value. This is for the purpose of confirming whether or not correct matching occurs between respective points of the paths. Assuming two paths P={(p₀,0) (P₁,1) (P₂,2) (p₃,3)} and Q={(q₀,0) (q₁,3)}, there are three methods for pairing every point of the paths in the above manner, as shown in FIG. 7.

The similarity between paths in each case is obtained as follows: in the case of (a), Sim(p₀,q₀)+Sim(p₁,q₀)+Sim (p₂,q₀)+Sim(p₃,q₃)=2.013; in the case of (b), Sim (p₀,q₀)+Sim (p₁,q₀)+Sim(p₂,q₃)+Sim (p₃,q₃)=2.262; and, in the case of (c), Sim (p₀, q₀)+Sim (p₁, q₃)+Sim (p₂, q₃)+Sim (p₃, q₃)=1.394. Therefore, for both paths P and Q, max(2.013, 2.262, 1.394)=2.262, and, among the results of node matching between paths for cases (a), (b), and (c), that of (b) is selected. Assuming P={(P_{0,0}) (P_{1,1}) . . . (Pᵢ, tᵢ)} and Q={(q_{0,0}) (q_{1,1}) . . . (qⱼ,tⱼ)}, the similarity is defined by equation (7) below.
PathSim(P,Q)=g(pᵢ,qⱼ) (7)

Wherein, g(i,j) can be expressed as a recursive formula defined by equation (8) below.

$$g ( {p}_{i} , {q}_{j} ) = \{ \begin{matrix}max \{ \begin{matrix}nodeSim ( {p}_{i} , {q}_{j} ) + g ( {p}_{i} - 1 , {q}_{j} ) \\ nodeSim ( {p}_{i} , {q}_{j} ) + g ( {p}_{i} , {q}_{j} - 1 ) \\ nodeSim ( {p}_{i} , {q}_{j} ) + g ( {p}_{i} - 1 , {q}_{j} - 1 )\end{matrix} \} , & if i \geq 0 \& j \geq 0 \\ 0 , & otherwise\end{matrix} \qquad ( 8 )$$

This method is similar to dynamic time warping, and the above formula can be solved based on a dynamic programming technique. The dynamic time warping method considers the order of movement for each point of the paths during matching.

Prediction of information regarding the current movement path will now be described with regard to the above-mentioned concept of similarity between paths. Particularly, assuming that data regarding past movement paths of the user is given and that the user is currently moving along path Q, a method for selecting a representative path for predicting the destination of the user, the path the user is likely to select, the time at which he/she is supposed to reach a specific point, the location he/she is going to be at specific point of time, etc. will now be described together with prediction based on the method.

In this regard, path selection means that, when past paths P₁, P₂, . . . , Pᵢ are given and the user is currently moving along path Q, the final destination of the user and the points the user is supposed to go through are predicted based on the past paths.

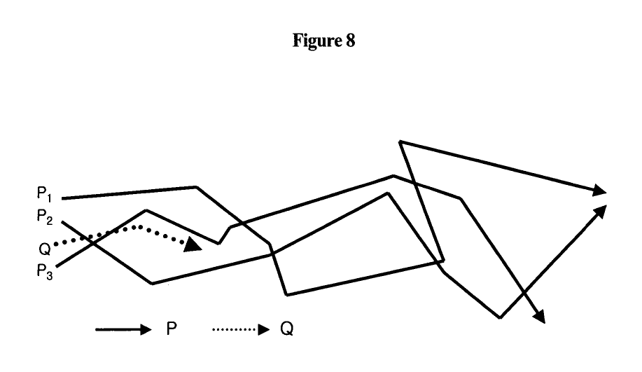

Assuming that data regarding past paths P₁, P₂, and P₃ is collected as shown in FIG. 8 and that the user is currently moving along path Q, the present invention aims at predicting the final destination of the user and the points he/she is supposed to go through with reference to the data.

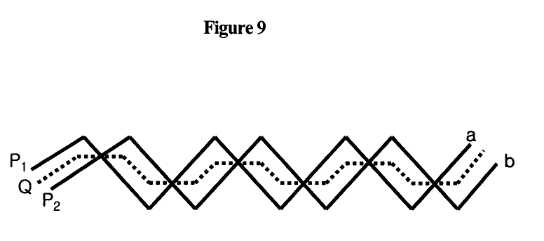

According to the present invention, paths similar to the user's current movement path are selected from the data regarding past movement paths, and necessary information is collected from the selected paths. However, even when an average path is created based on overall consideration of a number of paths so that it can represent them, it is difficult to give the average path a practical meaning, due to the nature of paths. For example, when path P₁ has destination a and path P₂ has destination b as shown in FIG. 9, it may be unacceptable to simply average both paths and use resulting path Q as a representative path together with a representative destination.

This is because path Q may include points with no practical meaning, and the average of paths is very difficult to define by nature. For these reasons, the present invention selects paths similar to the user's current movement path and chooses a representative path which can represent them.

The analysis of movement paths may be suited more to dynamic (i.e. moving) objects than to static objects. In order to predict the path of a moving object, the similarity between each collected past path P and the current movement path Q is measured. Then, paths having a satisfactory level of similarity are selected and used for services.

When collected movement paths are analyzed and compared with the current movement path, which has a lesser length, the resulting similarity based on the short path alone may have poor reliability. For example, if a collected path P is as long as 100 m and the current movement path Q is just 10 m, selection of a path based on analysis and comparison between them may pose a reliability problem. Therefore, the present invention uses a weight in proportion to the length of the current movement path so that a movement path is selected in a reliable manner.

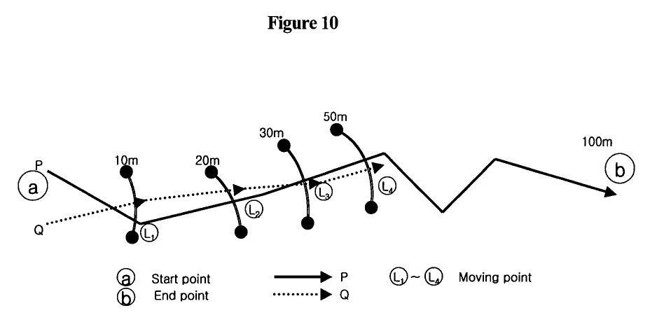

FIG. 10 shows a collected path P and a current movement path Q. The entire length of path P is 100 m and, when the user has traveled 10 m, 20 m, 30 m, and 50 m along path Q, corresponding locations are labeled L₁, L₂, L₃, and L₄, respectively. Based on an assumption that the user is currently at L₁, the proportion between the length of path Q to that of path P is calculated as 10/100=0.1, which is reflected in the evaluation of the similarity between both paths. If the current location is L₄, a proportion of 0.4 is similarly reflected in selection of similar paths.

As mentioned above, the method for predicting the spatial/temporal location of a moving object based on data regarding movement paths according to the present invention is advantageous in that it can obtain temporal information regarding the destination or a specific location related to a selected movement path. This makes it possible to predict the destination of a moving user, the path the user is likely to select, the location he/she is supposed to reach at a specific point of time, the time at which he/she is going to reach a specific location, etc.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for predicting a spatial/temporal location of a moving object based on movement path data, the method comprising the steps of:
defining a similarity function based on a location of each point of a movement path of a user, a time point when the user arrives at the location, and a movement direction of the user so that similarity between a collected path and a current movement path can be measured;
measuring similarity between paths based on dynamic time warping; and
predicting a movement path of the user based on the measurement.

2. The method as claimed in claim 1, wherein similarity between a point P(pᵢ, tᵢ) and a point Q(qⱼ, tⱼ) is defined by the equation
$$nodeSim ( {p}_{i} , {q}_{j} ) = {{C}_{1}^{D} [ cos \frac{θ}{2} ]}^{{C}_{2}} {C}_{3}^{T}$$
wherein, C₁, C₂, and C₃ refer to constants regarding distance, direction, and time, respectively; T=|tᵢ-tⱼ|; D refers to the distance between two points pᵢ and qⱼ; and θ refers to the included angle between pᵢ and qⱼ.

3. The method as claimed in claim 2, wherein the constants C₁, C₂, and C₃ are determined by the user.

4. The method as claimed in claim 2, wherein the similarity nodeSim (pᵢ, qⱼ) has a result value between 0 and 1, and a similarity threshold value is determined according to circumstances and conditions so that a suitable path is selected.

5. The method as claimed in claim 2, wherein the included angle is calculated by the equation
$$θ = \{ \begin{matrix}{cos}^{- 1} \frac{( {p}_{i} - {p}_{i - 1} ) \cdot ( {q}_{j} - {q}_{j - 1} )}{\vert {p}_{i} - {p}_{i - 1} \vert \vert {q}_{j} - {q}_{j - 1} \vert} , & if i \neq 0 \& j \neq 0 \\ 0 , & otherwise .\end{matrix}$$

6. The method as claimed in claim 2, wherein similarity between paths P and Q is calculated by the equation
$$PathSim ( P , Q ) = max {\sum }_{i = 0 , j = 0}^{m , n} nodeSim ( {p}_{i} , {q}_{j} ) .$$

7. The method as claimed in claim 2, further comprising a step of selecting paths similar to the current movement path of the user based on similarity measurement and choosing from the selected paths a path that can represent the selected paths.

8. The method as claimed in claim 2, wherein, when similarity between a collected movement path and the current movement path is measured, a weight is given in proportion to the length of the current movement path.

9. A method for predicting a spatial/temporal location of a moving object based on movement path data, the method comprising the steps of:
collecting past movement paths of a user;
measuring a matching degree between the past movement paths;
selecting matching movement paths from all past movement paths and excluding non-matching movement paths based on the measured matching degree;
measuring similarity between each matching past movement path and a movement path of the user up to the present time so as to analyze movement characteristics of the currently moving user; and
predicting a spatial location of the moving user based on the measured similarity.

10. The method as claimed in claim 9, further comprising, after the step of measuring similarity, a step of selecting suitable paths having a similarity measurement value within a similarity threshold.

11. The method as claimed in claim 9, further comprising a step of choosing from the selected paths a path that can represent the selected paths.

12. The method as claimed in claim 9, wherein the matching degree and the similarity are measured by an identical method.

13. The method as claimed in claim, 9, wherein a spatial/temporal prediction service is provided based on the selected paths.

14. The method as claimed in claim 12, wherein similarity between a point p(pᵢ, tᵢ) and a point Q(qⱼ, tⱼ) is defined by the equation
$$nodeSim ( {p}_{i} , {q}_{j} ) = {{C}_{1}^{D} [ cos \frac{θ}{2} ]}^{{C}_{2}} {C}_{3}^{T}$$
wherein, C₁, C₂, and C₃ refer to constants regarding distance, direction, and time, respectively; T=|tᵢ-tⱼ|; D refers to the distance between two points pᵢ and qⱼ; and θ refers to the included angle between pᵢ and qⱼ.

15. The method as claimed in claim 14, wherein the constants C₁, C₂, and C₃ are determined by the user.

16. The method as claimed in claim 14, the similarity nodeSim (pᵢ,qⱼ) has a result value between 0 and 1, and a similarity threshold value is determined according to circumstances and conditions so that a suitable path is selected.

17. The method as claimed in claim 14, wherein the included angle is calculated by the equation
$$θ = \{ \begin{matrix}{cos}^{- 1} \frac{( {p}_{i} - {p}_{i - 1} ) \cdot ( {q}_{j} - {q}_{j - 1} )}{\vert {p}_{i} - {p}_{i - 1} \vert \vert {q}_{j} - {q}_{j - 1} \vert} , & if i \neq 0 \& j \neq 0 \\ 0 , & otherwise .\end{matrix}$$

18. The method as claimed in claim 14, wherein similarity between paths P and Q is calculated by the equation
$$PathSim ( P , Q ) = max {\sum }_{i = 0 , j = 0}^{m , n} nodeSim ( {p}_{i} , {q}_{j} ) .$$

19. The method as claimed in claim 14, wherein, when similarity between a collected movement path and a current movement path is measured, a weight is given in proportion to the length of the current movement path.
